(19) United States
(12) Patent Application Publication
(10) Pub. No.: US 2017/0318013 A1
(43) Pub. Date: Nov. 2, 2017

(54) METHOD AND SYSTEM FOR VOICE-BASED USER AUTHENTICATION AND CONTENT EVALUATION

(71) Applicant: YEN4KEN, INC., Princeton, NJ (US)

(72) Inventors: Shourya Roy, Bangalore (IN); Kundan Shrivastava, Bangalore (IN); Om D Deshmukh, Bangalore (IN)

(21) Appl. No.: 15/142,239

(22) Filed: Apr. 29, 2016

(51) Int. Cl. H04L 29/06; G06F 21/32; G06F 21/36; G10L 17/22

(52) U.S. Cl. CPC H04L 63/0861; G10L 17/22; G06F 21/32; G06F 21/36

(57) ABSTRACT

The disclosed embodiments illustrate methods for voice-based user authentication and content evaluation. The method includes receiving a voice input of a user from a user-computing device, wherein the voice input corresponds to a response to a query. The method further includes authenticating the user based on a comparison of a voiceprint of the voice input and a sample voiceprint of the user. Further, the method includes evaluating content of the response of the user based on the authentication and a comparison between text content and a set of pre-defined answers to the query, wherein the text content is determined based on the received voice input.

### TECHNICAL FIELD

The presently disclosed embodiments are related, in general, to multimedia content processing. More particularly, the presently disclosed embodiments are related to methods and systems for voice-based user authentication and content evaluation.

### BACKGROUND

Recent advancements in the fields of computer networks and information technology have led to the usage of Massive Open Online Courses (MOCCs) as a popular mode of learning. Under this model, educational organizations provide multimedia content in the form of video lectures, and/or audio lectures to students for such learning. During video lectures, the students may be authenticated and thereafter presented with one or more queries, based on the multimedia content, during the online course, for evaluation of the students.

In certain scenarios, a onetime authentication of users, such as students, is performed at the beginning of an online course. Once authenticated, the users may ask one or more queries in a “fixed format” (e.g., only integers or fractions) or “multiple choice format” that can be automatically evaluated. Therefore, in such scenarios, the process of assessment is limited to a particular format of queries that can be framed. Thus, online courses lack flexibility in assessing the knowledge of the students. Further, there is no face-to-face interaction among the students, tutors, and administrators during the online courses. Thus, an advanced mechanism, which is more efficient and extensive, is required, to enhance the credibility of the online courses.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there is provided a method for voice-based user authentication and content evaluation. The method includes receiving, by one or more transceivers, a voice input of a user from a user-computing device, wherein the voice input corresponds to a response to a query. The method further includes authenticating, by one or more processors, the user based on a comparison of a voiceprint of the voice input and a sample voiceprint of the user. The method further includes evaluating, by the one or more processors, content of the response of the user based on the authentication and a comparison between text content and a set of pre-defined answers to the query, wherein the text content is determined based on the received voice input.

According to embodiments illustrated herein, there is provided a system for voice-based user authentication and content evaluation. The system includes one or more processors configured to operate one or more transceivers to receive a voice input of a user from a user-computing device, wherein the voice input corresponds to a response to a query. The one or more processors are further configured to authenticate the user based on a comparison of a voiceprint of the voice input and a sample voiceprint of the user, wherein the voiceprint is generated by performing one or more speech processing operations on the voice input. The one or more processors are further configured to evaluate content of the response of the user based on the authentication and a comparison between text content and a set of pre-defined answers to the query, wherein the text content is determined based on the received voice input, wherein the set of pre-defined answers comprises one or more correct answers, to the query, in a text format.

According to embodiments illustrated herein, there is provided a computer program product for use with a computing device. The computer program product comprises a non-transitory computer readable medium storing a computer program code for voice-based user authentication and content evaluation. The computer program code is executable by one or more processors in the computing device to operate one or more transceivers to receive a voice input of a user from a user-computing device, wherein the voice input corresponds to a response to a query. The computer program code is further executable by the one or more processors to authenticate the user based on a comparison of a voiceprint of the voice input and a sample voiceprint of the user, wherein the voiceprint is generated by performing one or more speech processing operations on the voice input. The computer program code is further executable by the one or more processors to evaluate content of the response of the user based on a comparison of text content and a set of pre-defined answers to the query, wherein the text content is determined based on the received voice input, wherein the set of pre-defined answers comprises one or more correct answers, to the query, in a text format.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram that illustrates a system environment, in which various embodiments can be implemented, in accordance with at least one embodiment;

FIG. 2 is a block diagram that illustrates a user-computing device, in accordance with at least one embodiment;

FIG. 3 is a block diagram that illustrates an application server, in accordance with at least one embodiment;

FIGS. 4A and 4B, collectively, depict a flowchart that illustrates a method for voice-based user authentication and content evaluation, in accordance with at least one embodiment;

FIG. 5A is a block diagram that illustrates an exemplary scenario for registration of a user on an online service platform, in accordance with at least one embodiment;

FIG. 5B is a block diagram that illustrates an exemplary scenario of voice-based user authentication and content evaluation, in accordance with at least one embodiment;

FIGS. 6A and 6B are block diagrams that illustrates exemplary Graphical User Interfaces (GUI) for presenting multimedia content on a user-computing device, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

### Definitions

The following terms shall have, for the purposes of this application, the meanings set forth below.

A “user-computing device” may refer to a computer, a device (that includes one or more processors/microcontrollers and/or any other electronic components), or a system (that performs one or more operations according to one or more programming instructions/codes) associated with a user. Examples of the user-computing device may include, but are not limited to, a desktop computer, a laptop, a personal digital assistant (PDA), a mobile device, a smartphone, and a tablet computer (e.g., iPad® and Samsung Galaxy Tab®).

A “user” may correspond to an individual, who is presented multimedia content on a user-computing device. In an embodiment, the user may correspond to a student taking an online course presented on the user-computing device. The user may be registered on an online service platform (e.g., an online educational service platform) that organizes the online course.

A “multimedia content” may correspond to at least one of audio content, video content, text content, an image, and an animation. In an embodiment, the multimedia content may be rendered through a media player, such as VLC Media Player®, Windows Media Player®, Adobe Flash Player®, Apple QuickTime Player®, etc., on a computing device. In an embodiment, the media player may include one or more coding/decoding libraries that enable the media player to render the multimedia content. In an embodiment, the multimedia content may be downloaded or streamed from a multimedia server to the computing device. In an alternate embodiment, the multimedia content may be stored on a media storage device, such as Hard Disk Drive, CD Drive, Pen Drive, and/or the like, connected to (or inbuilt in) the computing device. In an embodiment, the multimedia content may comprise one or more queries to be answered by a user.

A “query” may correspond to a question to be answered by a user. In an embodiment, the query may be embedded/overlaid in/on multimedia content. Further, the user viewing the multimedia content may provide a response to the query. In an embodiment, the query may be presented to the user in a text/graphical format and/or in an audio/video format.

A “response” may refer to an answer provided by a user in response to a query presented to the user in multimedia content. In an embodiment, the response may correspond to a text input provided by the user by use of an input device, such as a keyboard. In an alternate embodiment, the response may correspond to a voice input of the user provided by the use of another input device, such as a microphone. Hereinafter, the terms “response”, “user response”, and “response of a user” may be used interchangeably.

A “voice input” may refer to an audio input received from a user. In an embodiment, the user may utilize one or more devices, such as a microphone and/or the like, for providing the voice input. In an embodiment, the user may provide the voice input in response to each of one or more queries in multimedia content.

A “voiceprint” may refer to one or more audio features extracted from a voice input of a user. In an embodiment, one voiceprint may be associated with a particular user. Thus, the voiceprint of the user may be utilized to confirm the identity of the user. For example, a voiceprint “ [symbol] _1” of a first user may comprise one or more first values for one or more audio features and a voiceprint “ [symbol] _2” of a second user may comprise one or more second values for the one or more audio features. The one or more first values are different from the one or more second values. Further, if a voiceprint of a user matches with “ [symbol] _1”, then the user is identified as the first user. Examples of the one or more audio features may include pitch, energy, rhythm, spectrum, glottal pulse, phones, idiolect, semantics, accent, pronunciation and/or the like.

A “sample voiceprint” may refer to a voiceprint of a user generated during a registration of the user. In an embodiment, the sample voiceprint may comprise one or more values for one or more audio features. In an embodiment, a voiceprint of the user may be compared with the sample voiceprint to authenticate the user. For example, a voiceprint “ [symbol] _1” of a first user may be compared with a sample voiceprint “S_1” of the first user, based on which the identity of the first user is confirmed and the first user is authenticated. Another voiceprint “ [symbol] _2” of a second user may also be compared with the sample voiceprint “S_1” of the first user, however in this case the voiceprint “ [symbol] _2” of a second user doesn't match the sample voiceprint “S_1” of the first user. Thus, the identity of the second user is not confirmed and the second user is not authenticated.

A “set of pre-defined answers” may comprise all possible correct answers to a query. In an embodiment, a tutor/examiner/instructor may provide the set of pre-defined answers for each query in multimedia content presented to a user during an online course. In an embodiment, a response provided by the user to a query may be compared with each pre-defined answer in the corresponding set of pre-defined answers. Based on the comparison, the response may be evaluated.

“Authentication” may refer to a process of confirming the identity of a user. In an embodiment, the user may be authenticated based on the combination of a user identification and a password. The user identification and the password may be assigned to the user at time of registration of the user with any online service platform. In another embodiment, one or more biometric features may be utilized for the authentication of the user such as, but not limited to, retina prints, fingerprints, and voiceprint. Samples of the retina prints, fingerprints, and/or voiceprint may be obtained from the user at the time of the registration. For example, a voiceprint “ [symbol] _1” of a user may be compared with a sample voiceprint “S_1” of the user to confirm the identity of the user. If the voiceprint “ [symbol] _1” matches the sample voiceprint “S_1”, the identity of the user is confirmed and the user is authenticated.

“Evaluation” may refer to an assessment of a response of a user to a query. In an embodiment, the evaluation of the content of the response may comprise a comparison between the response and a set of pre-defined answers to the query. For example, a response “R_1” of a user to a query “Q_1” is compared with a set of pre-defined answers “A_1” for assessing the correctness of the response “R_1”.

“One or more speech processing operations” may refer to one or more processing operations performed on an audio signal (e.g., a voice input). In an embodiment, the one or more speech processing operations may be performed on the voice input to extract one or more values for one or more audio features associated with the voice input. Examples of the one more speech processing operations may include pitch tracking, rhythm, tracking, frequency tracking, spectrogram computation, energy computation and/or the like.

A “language model” may refer to a statistical model comprising a probability distribution over a sequence of one or more words. In an embodiment, the language model may be utilized to assign a probability to the one or more words in the sequence. In an embodiment, a language model may be trained for a particular domain, such as sports, linear algebra, chemistry and/or the like. An in-domain language model may be utilized in speech to text conversion techniques for accurate conversion, when the speech (i.e., a voice input) is associated with a specific domain.

A “first notification” may refer to a notification presented to a user, when the authentication of the user fails. In an embodiment, upon receiving the first notification streaming of multimedia content to a user computing device may be precluded. In an embodiment, the first notification may present a message to the user to notify the user about the failed authentication.

An “overlay score” may refer to a score that is indicative of a degree of similarity between two instances of text content. The overlay score is generated by comparing the two text content. In an embodiment, the overlay score may be represented as a percentage of similarity between two text content. In an embodiment, the overlay score may be utilized to assess the correctness of a response of a user to a query.

A “second notification” may refer to a notification presented to a user, when the user is authenticated. In an embodiment, the second notification may comprise an evaluation result (e.g., an overlay score) of content of a response of the user.

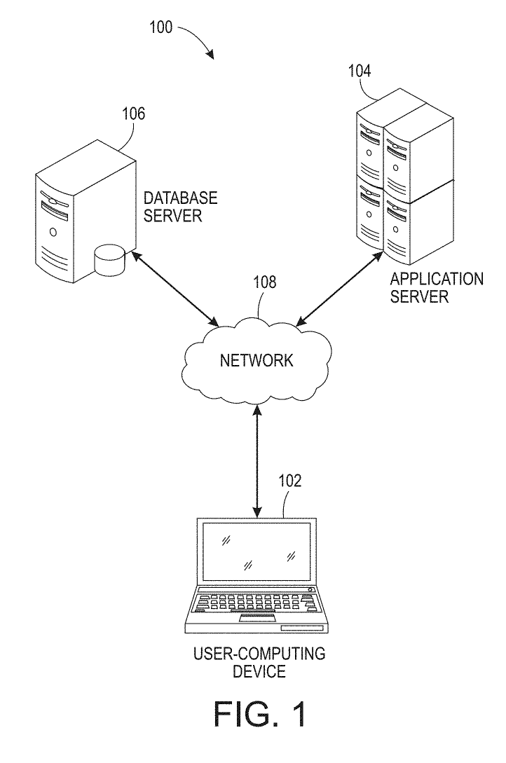

FIG. 1 is a block diagram of a system environment in which various embodiments may be implemented. With reference to FIG. 1, there is shown a system environment 100 that includes a user-computing device 102, an application server 104, a database server 106, and a network 108. Various devices in the system environment 100 may be interconnected over the network 108. FIG. 1 shows, for simplicity, one user-computing device 102, one application server 104, and one database server 106. However, it will be apparent to a person having ordinary skill in the art that the disclosed embodiments may also be implemented using multiple user-computing devices, multiple application servers, multiple database servers, without departing from the scope of the disclosure.

In an embodiment, the user-computing device 102 may refer to a computing device associated with a user that may be communicatively coupled to the network 108. The user-computing device 102 may include one or more processors and one or more memories. The one or more memories may include computer readable codes and instructions that may be executable by the one or more processors to perform predetermined operations as specified by the user. The predetermined operations may include receiving a live-stream of multimedia content, and displaying the multimedia content to the user associated with the user-computing device 102.

In an embodiment, the user may utilize the user-computing device 102 to register on an online service platform (e.g., an online educational service platform). During registration, the user may submit a user profile and a sample voice input by utilizing the user-computing device 102. Further, the user-computing device 102 may be configured to transmit the sample voice input of the user to the application server 104, over the network 108. In an embodiment, the user may utilize the user-computing device 102 for viewing the multimedia content. Further, the user may utilize the user-computing device 102 for submitting a response, as a voice input, for each of one or more queries in the multimedia content. Thereafter, the user-computing device 102 may be configured to transmit the user response to the application server 104, over the network 108. In an embodiment, the user-computing device 102 may be configured to display a first notification or a second notification, received from the application server 104, to the user.

The user-computing device 102 may correspond to a variety of computing devices such as, but not limited to, a laptop, a PDA, a tablet computer, a smartphone, and a phablet.

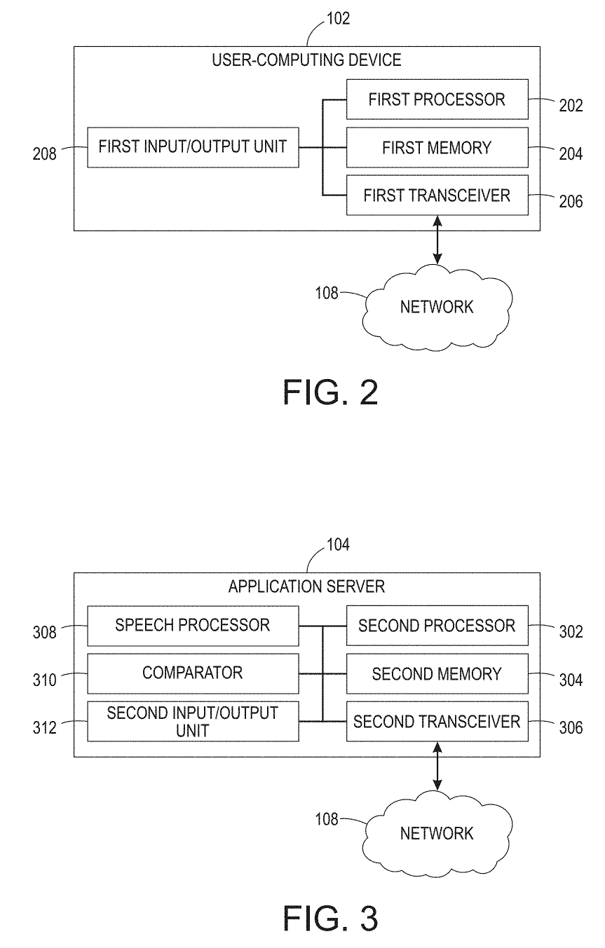

An embodiment of the structure of the user-computing device 102 has been discussed later in FIG. 2.

A person having ordinary skill in the art will understand that the scope of the disclosure is not limited to the utilization of the user-computing device 102 by a single user. In an embodiment, the user-computing device 102 may be utilized by more than one users to view the multimedia content.

In an embodiment, the application server 104 may refer to a computing device or a software framework hosting an application or a software service that may be communicatively coupled to the network 108. In an embodiment, the application server 104 may be implemented to execute procedures such as, but not limited to, programs, routines, or scripts stored in one or more memories for supporting the hosted application or the software service. In an embodiment, the hosted application or the software service may be configured to perform one or more predetermined operations. In an embodiment, the one or more predetermined operations may include an authentication of the user and an evaluation of content of the user response to a query.

In an embodiment, the application server 104 may be configured to receive the sample voice input of the user. Thereafter, the application server 104 may generate a sample voiceprint of the user based on the received sample voice input. The application server 104 may store the generated sample voiceprint of the user in the database server 106, over the network 108. In an embodiment, the application server 104 may utilize the sample voiceprint of the user to authenticate of the user.

In an embodiment, the application server 104 may be configured to stream the multimedia content on the user-computing device 102, when the user logs in to the online service platform by submitting a user identification and a password. The user identification and the password may be assigned to the user during the registration of the user. In an embodiment, the application server 104 may query the database server 106 to retrieve the user profile of the user, when the user logs in. Further, the application server 104 may select the multimedia content based on the retrieved user profile of the user.

In an embodiment, the multimedia content may comprise the one or more queries to be answered by the user. In an embodiment, the application server 104 may receive the user response (i.e., the voice input) from the user-computing device 102 associated with the user. The user may provide the response, when he/she encounters the query while viewing the multimedia content on the user-computing device 102. Thereafter, the application server 104 may be configured to generate the voiceprint of the user from the received voice input. In an embodiment, the application server 104 may compare the generated voiceprint with the sample voiceprint of the user for the authentication of the user. In an embodiment, the application server 104 may preclude the live-stream of the multimedia content on the user-computing device 102, when the authentication of the user fails. The application server 104 may be further configured to transmit the first notification to the user-computing device 102, over the network 108, when the authentication of the user fails. In an alternate embodiment, the application server 104 may be configured to transmit the second notification to the user-computing device 102, over the network 108, when the user is authenticated. In an embodiment, the second notification may comprise an overlay score.

In an embodiment, the application server 104 may be configured to evaluate the content of the user response in parallel to the authentication of the user. In another embodiment, the application server 104 may be configured to evaluate the content of the user response after the user has been authenticated. For the evaluation of the content of the user response, the application server 104 may be configured to convert the content of the user response (i.e., one or more words uttered by the user in the voice input) into text content. The application server 104 may utilize one or more speech to text conversion techniques for converting the content of the user response into the text content. Examples of such one or more speech to text conversion techniques include, but may not be limited to, Hidden Markov Model (HMM) technique, neural network technique, and Dynamic-time warping technique. Thereafter, the application server 104 may compare the text context with a set of pre-defined answers.

Prior to the comparison, the application server 104 may be configured to query the database server 106 to extract the set of pre-defined answers associated with the query. The set of pre-defined answers associated with the query may comprise one or more correct answers to the query in a text format. Further, based on the comparison, the application server 104 may be configured to determine the overlay score for the user response. In an embodiment, the overlay score corresponds to a degree of similarity between the text content and the set of pre-defined answers. The application server 104 may be configured to transmit the overlay score to the user-computing device 102, over the network 108, when the user is authenticated. Further, the application server 104 may be configured to extract an evaluation record of the user from the database server 106. The evaluation record of the user may comprise a performance report of the user. Thereafter, the application server 104 may update the evaluation record based on the overlay score, when the user is authenticated.

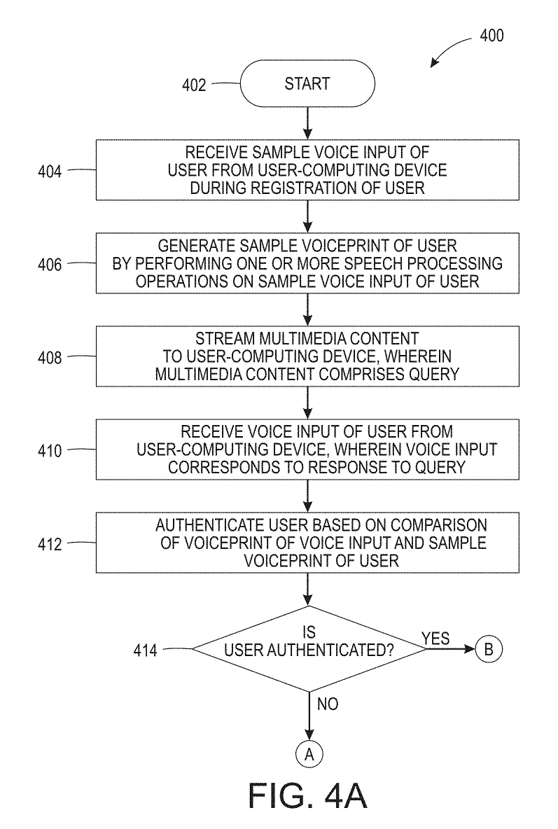

The application server 104 may be realized through various types of application servers such as, but not limited to, a Java application server, a .NET framework application server, a Base4 application server, a PHP framework application server, or any other application server framework. The operation of the application server 104 has been discussed later in FIG. 3.

In an embodiment, the database server 106 may refer to a computing device that may be communicatively coupled to the network 108. In an embodiment, the database server 106 may be configured to store multimedia content, received from a multimedia content server (not shown). In another embodiment, a registered examiner or a registered tutor associated with the online service platform (e.g., the online educational service platform) may transmit the multimedia content to the database server 106, by use of another user-computing device (not shown). In an embodiment, the stored multimedia content may comprise one or more built-in queries. In another embodiment, when multimedia content does not comprise the one or more queries, the registered examiner or the registered tutor may embed the one or more queries in the multimedia content before storing the multimedia content in the database server 106. The registered examiner or the registered tutor may utilize one or more multimedia processing techniques, known in the art, for the insertion of the one or more queries in the multimedia content. In an embodiment, the multimedia content may be associated with a specific topic or domain. The one or more queries in the multimedia content may be associated with the corresponding topic or the corresponding domain of the multimedia content. In an embodiment, the database server 106 may be further configured to store the user profile, the sample voiceprint, the voiceprint, and the evaluation record of the user, received from the application server 104. In an embodiment, the database server 106 may be further configured to store the set of pre-defined answers for each of the one or more queries in the multimedia content. In an embodiment, the registered examiner or the registered tutor, who transmitted the multimedia content, may further transmit the set of pre-defined answers for each of the one or more queries in the corresponding multimedia content, to the database server 106 by use of the another user-computing device (not shown).

In an embodiment, the database server 106 may be further configured to store an in-domain language model associated with the multimedia content. In an embodiment, the registered examiner or the registered tutor, who transmitted the multimedia content, may further transmit the in-domain language model associated with the corresponding multimedia content, over the network 108. In an alternate embodiment, the application server 104 may transmit the in-domain language model associated with the multimedia content. Prior to transmission, the application server 104 may extract the in-domain language model associated with the multimedia content from one or more online websites.

Further, in an embodiment, the database server 106 may be configured to transmit/receive one or more instructions/queries/information to/from one or more devices (i.e., the user-computing device 102 and the application server 104) over the network 108. In an embodiment, the database server 106 may receive a query from the application server 104 to retrieve the user profile, the sample voiceprint, the voiceprint, the pre-defined set of answers, the in-domain language model, and the evaluation record of the user. For querying the database server 106, one or more querying languages may be utilized, such as, but not limited to, SQL, QUEL, DMX and so forth. Further, the database server 106 may be realized through various technologies, such as, but not limited to, Microsoft® SQL server, Oracle, and My SQL.

A person having ordinary skill in the art will appreciate that the scope of the disclosure is not limited to realizing the application server 104 and the database server 106 as separate entities. In an embodiment, the functionalities of the application server 104 can be integrated into the database server 106.

The network 108 corresponds to a medium through which content and messages flow between various devices of the system environment 100 (e.g., the user-computing device 102, the application server 104, and the database server 106). Examples of the network 108 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 108 in accordance with various wired and wireless communication protocols such as Transmission Control Protocol and Internet Protocol (TCP/IP), User Datagram Protocol (UDP), and 2G, 3G, or 4G communication protocols.

FIG. 2 is a block diagram that illustrates the user-computing device 102, in accordance with at least one embodiment. FIG. 2 has been described in conjunction with FIG. 1. In an embodiment, the user-computing device 102 may include a first processor 202, a first memory 204, a first transceiver 206, and a first input/output unit 208. The first processor 202 is coupled to the first memory 204, the first transceiver 206, and the first input/output unit 208.

The first processor 202 includes suitable logic, circuitry, and/or interfaces that are configured to execute one or more instructions stored in the first memory 204 to perform the one or more operations, specified by the user, on the user-computing device 102. The first processor 202 may be implemented using one or more processor technologies known in the art. Examples of the first processor 202 may include, but are not limited to, an X86 processor, a Reduced Instruction Set Computing (RISC) processor, an Application-Specific Integrated Circuit (ASIC) processor, a Complex Instruction Set Computing (CISC) processor, or any other processor.

The first memory 204 stores one or more sets of instructions, codes, programs, algorithms, data, and/or the like. Some of the commonly known memory implementations include, but are not limited to, a random access memory (RAM), a read only memory (ROM), a hard disk drive (HDD), a solid-state drive (SSD), and a secure digital (SD) card. Further, the first memory 204 includes the one or more sets of instructions that are executable by the first processor 202 to perform the one or more operations, specified by the user, on the user-computing device 102. It is apparent to a person having ordinary skills in the art that the one or more sets of instructions stored in the first memory 204 enable the hardware of the user-computing device 102 to perform the one or more user specified operations, without deviating from the scope of the disclosure.

The first transceiver 206 transmits and receives messages and data to/from various components of the system environment 100. In an embodiment, the first transceiver 206 may be communicatively coupled to the network 108. In an embodiment, the first transceiver 206 may be configured to receive the multimedia content from the application server 104 or the database server 106. Further, the first transceiver 206 may be configured to transmit the response of the user to the query to the application server 104, over the network 108. Examples of the first transceiver 206 may include, but are not limited to, an antenna, an Ethernet port, a USB port, or any other port that can be configured to receive and transmit data. The first transceiver 206 transmits and receives data/messages, in accordance with various communication protocols, such as, TCP/IP, UDP, and 2G, 3G, or 4G communication protocols.

The first input/output unit 208 may comprise suitable logic, circuitry, interfaces, and/or code that may be configured to receive an input from the user. The first input/output unit 208 may be configured to communicate with the first processor 202. In an embodiment, the first input/output unit 208 may present the user with the multimedia content. In an embodiment, the user may use the first input/output unit 208 to submit the response to the query in the multimedia content. In another embodiment, the first input/output unit 208 may display the first notification or the second notification to the user. Examples of the input devices may include, but are not limited to, a keyboard, a mouse, a joystick, a touch screen, a microphone, a camera, and/or a docking station. Examples of the output devices may include, but are not limited to, a display screen and/or a speaker.

FIG. 3 is a block diagram that illustrates the application server 104, in accordance with at least one embodiment. FIG. 3 has been described in conjunction with FIG. 1. In an embodiment, the application server 104 may include a second processor 302, a second memory 304, a second transceiver 306, a speech processor 308, a comparator 310, and a second input/output unit 312. The second processor 302 is communicatively coupled to the second memory 304, the second transceiver 306, the speech processor 308, the comparator 310 and the second input/output unit 312.

The second processor 302 includes suitable logic, circuitry, and/or interfaces that are configured to execute one or more instructions stored in the second memory 304. The second processor 302 may further comprise an arithmetic logic unit (ALU) (not shown) and a control unit (not shown). The ALU may be coupled to the control unit. The ALU may be configured to perform one or more mathematical and logical operations and the control unit may control the operation of the ALU. The second processor 302 may execute a set of instructions/programs/codes/scripts stored in the second memory 304 to perform one or more operations for the authentication of the user and the evaluation of the content of the user response. The second processor 302 may be implemented based on a number of processor technologies known in the art. Examples of the second processor 302 include, but are not limited to, an X86-based processor, a RISC processor, an ASIC processor, and/or a CISC processor.

The second memory 304 may be operable to store one or more machine codes, and/or computer programs having at least one code section executable by the second processor 302. The second memory 304 may store the one or more sets of instructions that are executable by the second processor 302, the second transceiver 306, the speech processor 308, the comparator 310, and the second input/output unit 312. In an embodiment, the second memory 304 may include one or more buffers (not shown). The one or more buffers may store at least one or more of, but are not limited to, the sample voiceprint, the voiceprint, and the overlay score. Some of the commonly known memory implementations include, but are not limited to, a random access memory (RAM), a read only memory (ROM), a hard disk drive (HDD), and a secure digital (SD) card. In an embodiment, the second memory 304 may include the one or more machine codes, and/or computer programs that are executable by the second processor 302 to perform specific operations. It will be apparent to a person having ordinary skill in the art that the one or more instructions stored in the second memory 304 may enable the hardware of the application server 104 to perform the predetermined operations, without deviating from the scope of the disclosure.

The second transceiver 306 transmits and receives messages and data to/from various components of the system environment 100, such as the user-computing device 102, and the database server 106, over the network 108. In an embodiment, the second transceiver 306 may be communicatively coupled to the network 108. In an embodiment, the second transceiver 306 may be configured to stream the multimedia content on the user-computing device 102, over the network 108. In an embodiment, the second transceiver 306 may be configured to transmit the first notification or the second notification to the user-computing device 102, over the network 108. Examples of the second transceiver 306 may include, but are not limited to, an antenna, an Ethernet port, a USB port, or any other port that can be configured to receive and transmit data. The second transceiver 306 receives and transmits the demands/content/information/notifications, in accordance with the various communication protocols, such as TCP/IP, UDP, and 2G, 3G, or 4G communication protocols.

The speech processor 308 may comprise suitable logic, circuitry, interfaces and/or code that may be configured to execute the one or more instructions stored in the second memory 304 to generate the sample voiceprint and the voiceprint, based on the sample voice input and voice input, respectively, for the authentication of the user. In an embodiment, the speech processor 308 may be further configured to convert the content of the voice input (i.e., the user response) of the user into the text content for the evaluation of the content of the user response. The speech processor 308 may utilize the one or more speech to text conversion techniques for converting the voice input of the user into the text content such as, but not limited to, HMM technique, neural network technique, and Dynamic-time warping technique. The speech processor 308 may be implemented using one or more processor technologies known in the art. Examples of the speech processor 308 include, but are not limited to, an X86, a RISC processor, a CISC processor, or any other processor. In another embodiment, the speech processor 308 may be implemented as an ASIC microchip designed for a special application, such as generating the sample voiceprint and the voiceprint and converting the voice input into the text content.

The comparator 310 comprises suitable logic, circuitry, interfaces and/or code that may be configured to execute the one or more instructions stored in the second memory 304 to compare the sample voiceprint with the voiceprint and the text content with the set of pre-defined answers to the query. In an embodiment, the comparator 310 may generate the overlay score based on the degree of similarity between the text content and the set of pre-defined answers.

In an embodiment, the comparator 310 may be realized through software or hardware technologies known in the art. Though, the comparator 310 is depicted as independent from the second processor 302 in FIG. 3, a person skilled in the art will appreciate that the comparator 310 may be implemented within the second processor 302, without departing from the scope of the disclosure.

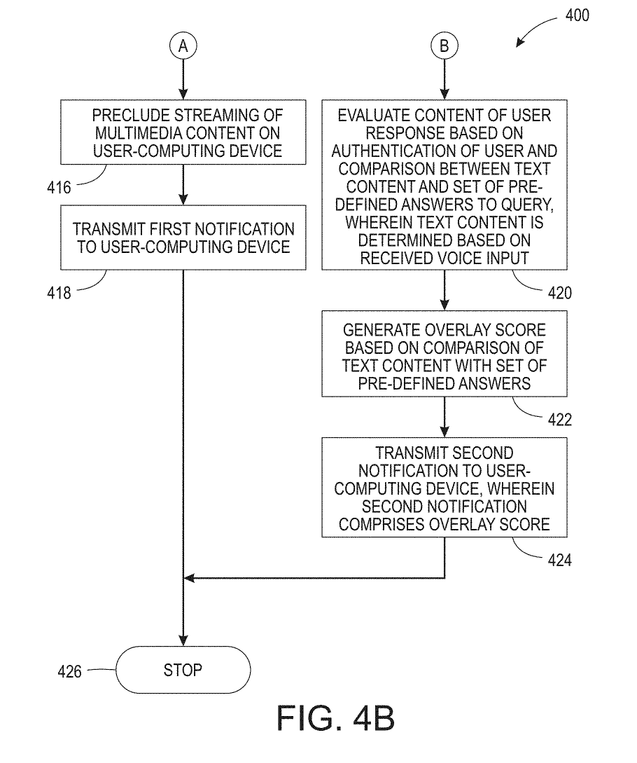

The second input/output unit 312 may comprise suitable logic, circuitry, interfaces, and/or code that may be configured to provide an output to the user. The second input/output unit 312 comprises various input and output devices that are configured to communicate with the second processor 302. Examples of the input devices include, but are not limited to, a keyboard, a mouse, a joystick, a touch screen, a microphone, a camera, and/or a docking station. Examples of the output devices include, but are not limited to, a display screen and/or a speaker. The working of the application server 104 to evaluate the response of the user to the query has been explained later in FIGS. 4A and 4B.

FIGS. 4A and 4B, collectively, depict a flowchart that illustrates a method for voice-based user authentication and content evaluation, in accordance with at least one embodiment. FIGS. 4A and 4B are described in conjunction with FIGS. 1-3. With reference to FIGS. 4A and 4B, there is shown a flowchart 400 that illustrates a method for evaluating the content of the user response to the query. For the purpose of ongoing description, the method has been explained for a query in the one or more queries in the multimedia content. However, the scope of the disclosure should not be construed limiting to the query. In an embodiment, the following steps can also be performed for the remaining one or more queries in the multimedia content. The method starts at step 402 and proceeds to step 404.

At step 404, the sample voice input of the user is received from the user-computing device 102 during the registration of the user. In an embodiment, the second transceiver 306, in conjunction with the second processor 302, may be configured to receive the sample voice input of the user. In an embodiment, the second processor 302 may be configured to assign a user identification and a password to the user, when the user registers on the online service platform. Further, the second transceiver 306 may be configured to receive the user profile and the sample voice input of the user during the registration of the user. In an embodiment, the user profile may comprise one or more topics of interests of the user. The user profile may further comprise information pertaining to one or more online courses that the user has opted for during the registration.

Prior to the reception of the sample voice input, in an embodiment, the second transceiver 306 may be configured to transmit a text snippet to the user-computing device 102, over the network 108. Thereafter, the user may utilize the first input/output unit 208 for recording the sample voice input by reciting the text displayed in the text snippet. Further, the second transceiver 306 may receive the recorded sample voice input of the user from the user-computing device 102, over the network 108. In an embodiment, the speech processor 308 may be configured to check a quality level associated with the sample voice input. For checking the quality level, the speech processor 308 may be configured to determine a recognition score for the sample voice input by utilizing one or more recognition confidence measurement techniques, known in the art, such as posterior probability technique, predictor analysis, HMM technique and/or the like. In an embodiment, the second transceiver 306 may transmit a message to the user-computing device 102 for the retransmission of the sample voice input, if the recognition score of the sample voice input is below a threshold value. In an embodiment, the speech processor 308 may be configured to determine the threshold value. In an alternate embodiment, the threshold value may be a fixed value defined by the examiner or the tutor associated with the online service platform. Thereafter, the user may retransmit the sample voice input, by utilizing the user-computing device 102, based on the received message.

At step 406, the sample voiceprint of the user is generated by performing the one or more speech processing operations on the sample voice input of the user. In an embodiment, the speech processor 308 in conjunction with the second processor 302 may be configured to generate the sample voiceprint of the user by performing the one or more speech processing operations on the sample voice input of the user. Examples of the one or more speech processing operations may include pitch tracking, rhythm, tracking, frequency tracking, spectrogram computation, energy computation and/or the like.

In an embodiment, the sample voiceprint may comprise one or more first values corresponding to one or more audio features. Examples of the one or more audio features may include pitch, energy, rhythm, spectrum, glottal pulse, phones, idiolect, semantics, accent, pronunciation and/or the like. Thereafter, the second transceiver 306 may be configured to store the sample voiceprint of the user in the database server 106.

A person having ordinary skill in the art will understand that the scope of disclosure is not limited to the abovementioned one or more audio features.

At step 408, the multimedia content is streamed to the user-computing device 102, wherein the multimedia content comprises the query. In an embodiment, the second transceiver 306 in conjunction with the second processor 302 may be configured to stream the multimedia content, comprising the query, to the user-computing device 102.

In an embodiment, to initiate the streaming of the multimedia content to the user-computing device 102 the user may be required to transmit a login request to the application server 104 associated with the online service platform. In an embodiment, the user may utilize the user identification and the password, assigned to the user, for raising the login request. Upon receiving the login request, the second processor 302 may verify whether the user is a registered user or not. For verification, the second transceiver 306 may query the database server 106 for extracting the user profile of the user associated with the user identification and the password. In a scenario, if the user is a registered user, the second transceiver 306 may receive the user profile, else the query may not fetch any result. After the verification of the registered user, the second processor 302 may utilize the user profile of the user to select the multimedia content that is to be streamed to the user-computing device 102.

In an embodiment, the second processor 302 may select the multimedia content based on the one or more topics of interest of the user and/or the information pertaining to the one or more courses the user may have opted for, in the user profile of the user. In an embodiment, the user profile may comprise the one or more topics of interest and/or the one or more courses opted by the user in order of preference of the user. Thus, the second processor 302 may select the multimedia content based on the preference of the user.

For example, the second processor 302 may extract user profiles of a first user (i.e., user_1) and a second user (e.g., user_2), from the database server 106, based on the login request of the first user and the second user. Table 1 illustrates the user profile of each of the first user and the second user.

TABLE 1
Illustration of user profiles of two users

| User | | |
|---|---|---|
| identification | Topics of interest | Registered courses |
| User_1 | Football | Mathematics |
| | Automobiles | History |
| | Current affairs | English |
| User_2 | Laws of motion | Basics of mathematics |
| | Linear algebra | Elementary physics |
| | Cricket | Elementary chemistry |

With reference to Table 1, the second processor 302 may select multimedia content associated with “football” for the first user and multimedia content associated with “laws of motion” for the second user. Similarly, multimedia content associated with “organic chemistry” may be selected for the second user but not for the first user.

A person having ordinary skill in the art will understand that the abovementioned example is for illustrative purpose and should not be construed limiting to the scope of the disclosure.

In an embodiment, the second processor 302 may select more than one multimedia content for the user, such that the selected multimedia content are streamed in succession to the user-computing device 102. In an embodiment, the second processor 302 may select the multimedia content based on the evaluation record of the user. In another embodiment, the second processor 302 may transmit an option to the user to select the multimedia content to be streamed. Thereafter, the second processor 302 may stream the multimedia content based on the selection of the user.

After the selection of the multimedia content, the second transceiver 306 may be configured to stream the multimedia content to the user-computing device 102 of the user. In an embodiment, the multimedia content streamed to the user-computing device 102 may comprise the one or more queries. In an embodiment, the one or more queries may be of different formats such as, but not limited to, a text query, a graphical query, and/or an audio query.

At step 410, the voice input of the user is received, wherein the voice input corresponds to the response to the query. In an embodiment, the second transceiver 306 in conjunction with the second processor 302 may be configured to receive the voice input of the user, wherein the voice input corresponds to the response to the query. In an embodiment, when the user viewing the multimedia content is presented with the query, he/she may submit the response (i.e., the answer) to the query by utilizing the user-computing device 102.

For answering the query, the user may record the voice input by utilizing the first input/output unit 208. Thereafter, the second transceiver 306 may receive the recorded voice input of the user from the user-computing device 102. In an embodiment, the speech processor 308 may be configured to check the quality level associated with the received voice input. For checking the quality level, the speech processor 308 may be configured to determine the recognition score for the received input. The speech processor 308 may utilize the one or more one or more recognition confidence measurement techniques, such as posterior probability technique, predictor analysis, HMM technique and/or the like. In an embodiment, the second transceiver 306 may transmit the message to the user-computing device 102 for the retransmission of the voice input, if the recognition score of the voice input is below the threshold value. Thereafter, based on the message the user may be prompted to retransmit the voice input, by utilizing the user-computing device 102, over the network 108.

At step 412, the user is authenticated based on the comparison of the voiceprint of the voice input and the sample voiceprint of the user. In an embodiment, the second processor 302, in conjunction with the comparator 310, may be configured to authenticate the user, based on the comparison of the voiceprint of the voice input and the sample voiceprint of the user. Prior to the comparison of the voice input and the sample voiceprint of the user, the speech processor 308 may be configured to generate the voiceprint of the user based on the received voice input.

In an embodiment, the speech processor 308 may generate the voiceprint of the user by performing the one or more speech processing operations on the received voice print of the user. Examples of the one or more speech processing operations may include pitch tracking, rhythm tracking, frequency tracking, spectrogram computation, energy computation, and/or the like. The generated voiceprint may comprise one or more second values corresponding to the one or more audio features. Examples of the one or more audio features may include pitch, energy, rhythm, spectrum, glottal pulse, phones, idiolect, semantics, accent, pronunciation, and/or the like.

Thereafter, the second transceiver 306 may query the database server 106 to extract the sample voiceprint of the user stored during the registration of the user. After receiving the sample voiceprint, the comparator 310 may be configured to compare the voiceprint with the sample voiceprint of the user to check whether the voiceprint matches the sample voiceprint. For comparing the voiceprint with the sample voiceprint, the comparator 310 may compare the one or more second values of the one or more audio features in the voiceprint with the corresponding one or more first values of the one or more audio features in the sample voiceprint of the user. In an embodiment, the comparator 310 may generate an output “1,” if the voiceprint matches the sample voiceprint, else the output is “0.” The matching of the voiceprint with the sample voiceprint may indicate that the user, whose voice input was received, is the same as the user whose sample voiceprint was extracted from the database server 106. A mismatch between the voiceprint and the sample voiceprint may indicate that the user, whose voice input was received, is different from the user whose sample voiceprint was extracted from the database server 106. Thus, the comparator 310 may authenticate the user, based on a match between the voiceprint and the sample voiceprint. For example, Table 2 illustrates an exemplary scenario, when each of two registered users transmits a login request for viewing the multimedia content.

TABLE 2
Illustration of the comparator output corresponding to login
requests raised by each of the two users

| | | User identification | |
|---|---|---|---|
| | Assigned user | used for raising the | Comparator |
| User | identification | login request | output |
| First user | User_1 | User_1 | 1 |
| Second user | User_2 | User_3 | 0 |

With reference to Table 2, the first user uses the same user identification (i.e., “User_1”) that was assigned to the first user during the registration. Thus, the comparator 310 may generate an output “1” based on the determination that the sample voiceprint of the first user matches the voiceprint of the first user. Further, the second user uses different user identification (i.e., “User_3”) from the assigned user identification (i.e., “User_2”) for raising the login request. Thus, the comparator 310 may generate an output “0” based on the determination that the sample voiceprint corresponding to a user with user identification “User_3” failed to match the voiceprint of the second user. In another embodiment, the second user may not be a registered user. For raising the login request to view the multimedia content, the second user may utilize a user identification and a password of a registered user (e.g., “User_3”). In such a case, the comparator 310 may give an output “0” based on the determination that the sample voiceprint corresponding to the user identification “User_3” failed to match the voiceprint of the second user.

A person having ordinary skill in the art will understand that the abovementioned exemplary scenario is for illustrative purpose and should not be construed to limit the scope of the disclosure.

At step 414, a check is performed for authentication of the user. In an embodiment, the second processor 302 may be configured to perform the check for authentication of the user. In an embodiment, if the second processor 302 may determine that the authentication of the user has failed, then the control passes to step 416. In an alternate embodiment, if the second processor 302 may determine that the user is authenticated, then control passes to step 420.

At step 416, streaming of the multimedia content to the user-computing device 102 is precluded. In an embodiment, the second processor 302, in conjunction with the second transceiver 306, may be configured to preclude the streaming of the multimedia content to the user-computing device 102. The second transceiver 306 may be configured to preclude the live-stream of the multimedia content, when the authentication of the user fails.

At step 418, the first notification is transmitted to the user-computing device 102. In an embodiment, the second transceiver 306, in conjunction with the second processor 302, may be configured to transmit the first notification to the user-computing device 102. In an embodiment, the second transceiver 306 may transmit the first notification to the user in an event of failed authentication. The first notification may comprise an authentication failed message for the user. In an embodiment, based on the first notification the user may be prompted to raise the login request again.

In an alternate embodiment, based on the first notification the user may be prompted to answer one or more security questions that the user may have previously answered during the registration. The comparator 310 may compare the answers to the one or more security questions with previous answers provided by the user. Based on the comparison by the comparator 310, the second processor 302 may determine whether the user answered the one or more security questions correctly or incorrectly. In an embodiment, the second transceiver 306 may transmit an alert message to a service provider of the online service platform, if the user answered the one or more security questions incorrectly. In another embodiment, the second transceiver 306 may store the voiceprint of the user in a spam group, if the user answered the one or more security questions incorrectly. The spam group may comprise the voiceprints of one or more users associated with a failed authentication.

In an embodiment, the second transceiver 306 may restart the streaming of the multimedia content to the user-computing device 102, if the user raises the login request again. In another embodiment, the second transceiver 306 may restart the streaming of the multimedia content to the user-computing device 102, if the user answers the one or more security question correctly. Then, the control passes to end step 426.

A person having ordinary skill in the art will understand that the scope of the disclosure is not limited to restart the streaming of the multimedia content to the user-computing device 102. In an alternate embodiment, the second transceiver 306 may not restart the streaming of the multimedia content to the user-computing device 102.

At step 420, the content of the user response is evaluated based on the authentication of the user and the comparison between the text content and the set of pre-defined answers to the query, wherein the text content is determined based on the received voice input. In an embodiment, the second processor 302 in conjunction with the comparator 310 may be configured to evaluate the content of the user response, based on the authentication of the user and the comparison between the text content and the set of pre-defined answers to the query.

Prior to the evaluation, the speech processor 308 may be configured to determine the text content, based on the received voice input. For determining the text content, the speech processor 308 converts the voice input into the text content based on the speech to text conversion technique. In an embodiment, the text content may comprise the one or more words uttered by the user in text format. In an embodiment, the speech processor 308 may utilize the one or more speech to text conversion techniques known in the art such as, but not limited to, HMM technique, acoustic modeling, neural network technique, and Dynamic-time warping technique. In an embodiment, the second transceiver 306 may query the database server 106 to extract the in-domain language model, associated with the multimedia content for the conversion of the voice input into the text content.

In an embodiment, the speech processor 308 may utilize the in-domain language model associated with the multimedia content to predict an occurrence of a word in the voice input of the user. The speech processor 308 may utilize “N” (e.g., “2”, “3”, or “4”) previously uttered words in the voice input to predict a next uttered word by utilizing the in-domain language model. For example, the speech processor 308 may determine “Newton's,” “laws,” and “of” as the three previously uttered words (i.e., N=3) in the voice input of the user. Thereafter, the speech processor 308 may utilize the in-domain language model associated with the multimedia content to predict “motion” as the next uttered word.

A person having ordinary skill in the art will understand that the scope of the abovementioned example is for illustrative purpose and should not be construed to limit the scope of the disclosure.

In an embodiment, the speech processor 308 may utilize an acoustic model for converting the voice input (i.e., the user response) into the text content. The speech processor 308 may train the acoustic model, based on the sample voice input received from the user during the registration. The speech processor 308 may utilize the trained acoustic model for converting the voice input into the text content. After the conversion of the voice input to the text content, the speech processor 308 may evaluate the content of the user response.

For evaluating the content of the user response, the second transceiver 306 may be configured to query the database server 106 to extract the set of pre-defined answers corresponding to the query. Thereafter, the comparator 310 may be configured to compare the text content with each answer in the set of pre-defined answers. For example, the comparator 310 may utilize an automatic keyword spotting technique for comparing the text content with each answer in the set of pre-defined answers. The second processor 302 may be configured to identify one or more keywords in the set of pre-defined answers by utilizing the automatic keyword spotting technique. Further, the comparator 310 may compare the identified one or more keywords with the one or more words in the text content to check the presence of the identified one or more keywords in the text content. Thereafter, based on the presence of the identified one or more keywords in the text content, the second processor 302 may evaluate the content of the user response.

A person having ordinary skill in the art will understand that the abovementioned example is for illustrative purpose and should not be construed to limit the scope of the disclosure.

At step 422, the overlay score is generated based on the comparison of the text content with the set of pre-defined answers. In an embodiment, the comparator 310, in conjunction with the second processor 302, may be configured to generate the overlay score based on the comparison of the text content with the set of pre-defined answers. In an embodiment, the overlay score may correspond to the degree of similarity between the text content and the set of pre-defined answers. The comparator 310 may be configured to determine the degree of similarity between the text content and the set of pre-defined answers based on an extent to which the one or more words in the text content matches with an answer in the set of pre-defined answers. In an embodiment, the comparator 310 may determine a percentage of the one or more words in the text content that match with an answer in the set of pre-defined answers. The percentage determined by the comparator 310 may correspond to the degree of similarity between the text content and the set of pre-defined answers. For example, the comparator 310 may determine that “70%” of the one or more words in the text content match with an answer in the set of pre-defined answers. Thus, “70%” may correspond to the degree of similarity between the text content and the set of pre-defined answers.

In another embodiment, the comparator 310 may determine a count of the one or more words in the text content that are similar to the one or more keywords in the set of pre-defined answers Thereafter, the second processor 302 may determine a ratio for the count of the similar one or more words and a count of the one or more keywords in the set of pre-defined answers. In an embodiment, the determined ratio may correspond to the degree of similarity. For example, the comparator 310 may determine that “7” words in the text content match with “7” keywords in the set of pre-defined answers. A count of keywords in the set of pre-defined answers may be “10.” In such a case, the degree of similarity may be “0.7.”

A person having ordinary skill in the art will understand that the abovementioned examples are for illustrative purposes and should not be construed to limit the scope of the disclosure. In an embodiment, the second processor 302 may be configured to omit one or more filler words (e.g., “you know,” “like,” “erm,” “well,” etc.) from the text content before the comparison of the text content with the set of pre-defined answers.

In an embodiment, the generated overlay score may correspond to an evaluation result of the user. In an embodiment, the comparator 310 may further compare the overlay score with an overlay threshold. In an embodiment, the overlay threshold may be fixed by the examiner or the tutor. In an alternate embodiment, the second processor 302 may be configured to determine the overlay threshold based on one or more rules set defined by the examiner or the tutor associated with the online service platform. The comparator 310 may identify the user response as a correct answer, if the overlay score exceeds the overlay threshold. Further, the comparator 310 may identify the user response as an incorrect answer, if the overlay score is below the overlay threshold. For example, the second processor 302 may determine an overlay threshold as “73%” and may generate an overlay score as “69%.” In such a case, the comparator 310 may compare the overlay threshold and the overlay score to determine that the user response to the query is incorrect.

A person having ordinary skill in the art may understand that the abovementioned example is for illustrative purpose and should not be construed to limit the scope of the disclosure.

At step 424, the second notification is transmitted to the user-computing device 102, wherein the second notification comprises the overlay score. In an embodiment, the second transceiver 306, in conjunction with the second processor 302, may be configured to transmit the second notification to the user-computing device 102. The second notification comprises the generated overlay score. The second transceiver 306 may transmit the second notification to the user-computing device 102 associated with the user, when the user is authenticated. In an embodiment, the second notification may further comprise an indication to notify the user whether the transmitted user response was correct or incorrect. The second transceiver 306 may continue the streaming of the multimedia content after the transmission of the second notification. Then, control passes to end step 426.

A person having ordinary skill in the art will understand that the abovementioned steps of flowchart 400 may be performed in any order. In another embodiment, steps 420 and 422 may be performed in parallel with step 412, without altering the scope of the disclosure.

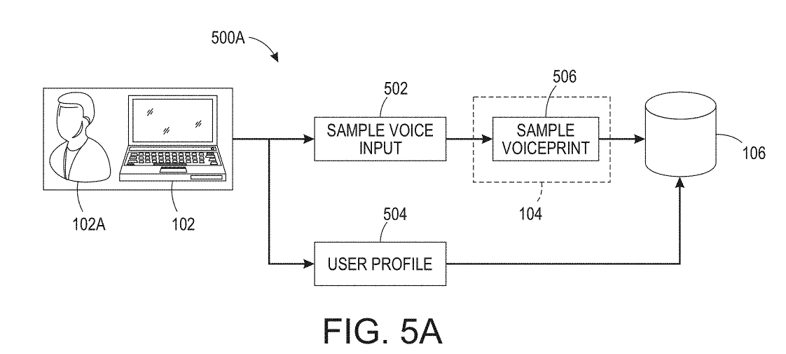

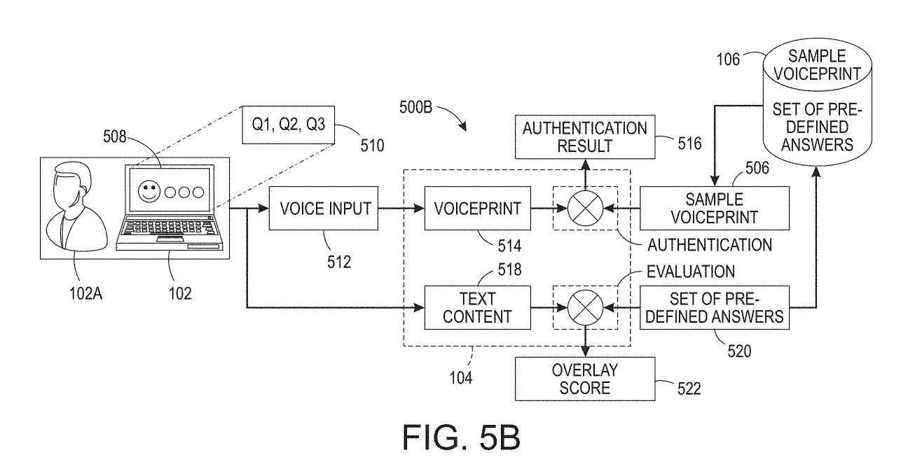

FIG. 5A is a block diagram that illustrates an exemplary scenario for registration of the user on an online service platform (e.g., an online educational service platform), in accordance with at least one embodiment. FIG. 5A has been explained in conjunction with FIG. 1, FIG. 2, FIG. 3, and FIG. 4.

With reference to FIG. 5A, there is shown an exemplary scenario 500a comprising the user-computing device 102, utilized by a user 102a for registering on the online educational service platform. The user 102a may transmit a sample voice input 502 and a user profile 504, by utilizing the user-computing device 102, to the application server 104. The application server 104 may generate a sample voiceprint 506 of the user 102a by utilizing one or more speech processing operations on the sample voice input 502. The second transceiver 306 may transmit the sample voiceprint 506 and the user profile 504 of the user 102a to the database server 106 for storage.

A person having ordinary skill in the art will understand that the abovementioned exemplary scenario is for illustrative purpose and should not be construed limiting to the scope of the disclosure.

FIG. 5B is a block diagram that illustrates an exemplary scenario of voice-based user authentication and content evaluation, in accordance with at least one embodiment. FIG. 5B has been explained in conjunction with FIG. 1, FIG. 2, FIG. 3, FIG. 4, and FIG. 5A. With reference to FIG. 5B, there is shown an exemplary scenario 500b for voice-based authentication of the user 102a and evaluation of content of a user response to a query in multimedia content.

The user 102a may transmit a login request to the application server 104 associated with the online educational service platform for viewing multimedia content 508 by utilizing the user-computing device 102. The application server 104 may stream the multimedia content 508 to the user-computing device 102, over the network 108. The multimedia content 508 may comprise one or more queries 510 to be answered by the user 102a. The user 102a may transmit a voice input 512 as a response to a query in the multimedia content 508 to the application server 104. The user 102a may utilize the user-computing device 102 for transmitting the voice input 512. Prior to transmission, the user 102a may record the voice input 512 by use of the first input/output unit 208. Thereafter, the application server 104 may perform an authentication of the user 102a and an evaluation of the content of the user response (i.e., the voice input 512).

For the authentication of the user, the application server 104 may generate a voiceprint 514 by utilizing the one or more speech processing operations on the voice input 512. Thereafter, the application server 104 may compare the voiceprint 514 of the user 102a with the sample voiceprint 506 of the user 102a. Prior to the comparison, the application server 104 may extract the sample voiceprint 506 from the database server 106. If the voiceprint 514 matches the sample voiceprint 506, the user 102a may be authenticated, else the authentication of the user 102a fails. The output (i.e., an authentication result 516) of the comparator 310 is based on the comparison between the voiceprint 514 and the sample voiceprint 506. In an embodiment, the application server 104 may transmit a first notification, such as “Authentication failed,” to the user-computing device 102 on the failure of the authentication of the user 102a. Further, the application server 104 may preclude the streaming of the multimedia content to the user-computing device 102, based on the authentication result 516. In an alternate embodiment, the application server 104 may transmit a second notification, such as “Authentication successful,” to the user-computing device 102, if the user 102a is authenticated.

In an embodiment, the evaluation of the content of the user response (i.e., the voice input 512), is based on the authentication of the user. For the evaluation of the content of the user response 512, the application server 104 may convert the voice input 512 into text content 518. Thereafter, the application server 104 may compare the text content 518 with a set of pre-defined answers 520. The application server 104 may extract the set of pre-defined answers 520, associated with the query, from the database server 106. Further, the application server 104 may generate an overlay score 522 based on the comparison of the text content 518 with the set of pre-defined answers 520. The application server 104 may transmit the overlay score 522 to the user-computing device 102, when the user is authenticated. The second notification comprises the overlay score 522. The application server 104 may continue to stream the multimedia content 508, when the user 102a is authenticated.

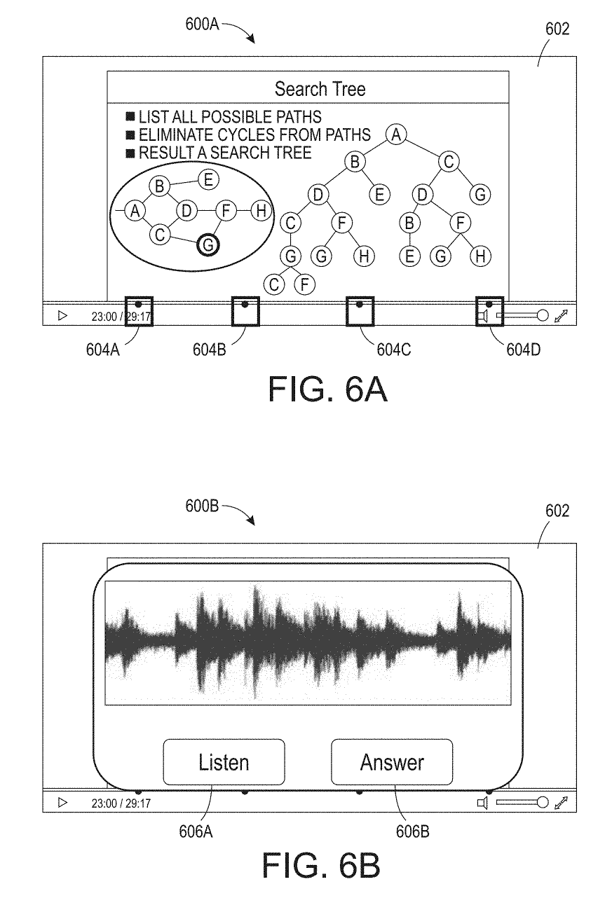

FIGS. 6A and 6B are block diagrams that illustrate exemplary Graphical User Interfaces (GUI) for presenting the multimedia content on the user-computing device 102, in accordance with at least one embodiment. FIGS. 6A and 6B have been explained in conjunction with FIG. 1, FIG. 2, FIG. 3, FIG. 4A, FIG. 4B, FIG. 5A, and FIG. 5B. With reference to FIGS. 6A and 6B, there are shown exemplary GUIs 600a and 600b, respectively, for presenting the multimedia content on the user-computing device 102.

The GUI 600a comprises a display area 602. The display area 602 displays the multimedia content. In an embodiment, the display area 602 may contain command buttons, such as play, rewind, forward, and pause, in order to control playback of the multimedia content. In an embodiment, a navigation bar may be displayed on the display area 602 that enables the user to navigate through the multimedia content. In an embodiment, during playback of the multimedia content, the display area 602 may display the duration of the multimedia content. The multimedia content may be embedded with one or more queries at one or more time instants, such as 604a, 604b, 604c, and 604d, of the multimedia content.

The GUI 600b comprises the display area 602. The display area 602 presents the query embedded in the multimedia content to the user. In an embodiment, if the query is in audio format, the user may click on a first button 606a, “LISTEN,” to listen to the query. The user may click on a second button 606b, “ANSWER,” to record an answer to the query. In an embodiment, the recorded answer may be transmitted to the application server 104 for the authentication of the user and the evaluation of the content of the user response (i.e., the recorded answer).

A person having ordinary skill in the art will understand that the abovementioned exemplary GUIs are for illustrative purpose and should not be construed limiting to the scope of the disclosure.

The disclosed embodiments encompass numerous advantages. The disclosure provides a method and a system for voice-based user authentication and content evaluation. The disclosed method and system enable simultaneous authentication of a user and evaluation of content of the user response during an online course. The disclosed method and system authenticate the user and evaluate content of a user response, based on a single voice input of the user. The process of the authentication is hidden from the user, as no additional information is required for authentication, such as user identification and password. Further, the disclosed method and system reduce an overhead for processing additional information for the authentication of the user.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for voice-based user authentication and content evaluation have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for voice-based user authentication and content evaluation, the method comprising:
receiving, by one or more transceivers, a voice input of a user from a user-computing device, wherein the voice input corresponds to a response to a query;
authenticating, by one or more processors, the user based on a comparison of a voiceprint of the voice input and a sample voiceprint of the user; and
evaluating, by the one or more processors, content of the response of the user based on the authentication and a comparison between text content and a set of pre-defined answers to the query, wherein the text content is determined based on the received voice input.

2. The method according to claim 1, wherein the authentication of the user and the evaluation of the content of the response are performed in parallel.

3. The method according to claim 1, further comprising receiving, by the one or more transceivers, a sample voice input of the user, from the user-computing device during a registration of the user.

4. The method according to claim 3, further comprising generating, by the one or more processors, the sample voiceprint of the user by performing one or more speech processing operations on the sample voice input of the user.

5. The method according to claim 1, further comprising streaming, by the one or more transceivers, multimedia content to the user-computing device, wherein the multimedia content comprises the query.

6. The method according to claim 5, further comprising precluding, streaming of the multimedia content to the user-computing device, when the authentication of the user fails.

7. The method according to claim 6, further comprising transmitting, by the one or more transceivers, a first notification to the user-computing device, when the authentication of the user fails.

8. The method according to claim 1, wherein the voiceprint is generated by performing one or more speech processing operations on the voice input.

9. The method according to claim 1, wherein the set of pre-defined answers comprises one or more correct answers, in a text format, corresponding to the query.

10. The method according to claim 1, further comprising generating, by the one or more processors, an overlay score based on the comparison of the text content with the set of pre-defined answers, wherein the overlay score corresponds to a degree of similarity between the text content and the set of pre-defined answers.

11. The method according to claim 10, further comprising transmitting, by the one or more transceivers, a second notification to the user-computing device, when the user is authenticated, wherein the second notification comprises the overlay score.

12. A system for voice-based user authentication and content evaluation, the system comprising:
one or more processors configured to:
operate one or more transceivers to receive a voice input of a user from a user-computing device, wherein the voice input corresponds to a response to a query;
authenticate the user based on a comparison of a voiceprint of the voice input and a sample voiceprint of the user, wherein the voiceprint is generated by performing one or more speech processing operations on the voice input; and
evaluate content of the response of the user based on the authentication and a comparison between text content and a set of pre-defined answers to the query, wherein the text content is determined based on the received voice input, wherein the set of pre-defined answers comprises one or more correct answers, to the query, in a text format.

13. The system according to claim 12, wherein the one or more processors are configured to authenticate the user and evaluate the content of the response in parallel.

14. The system according to claim 12, wherein the one or more processors are further configured to operate the one or more transceivers to receive a sample voice input of the user, from the user-computing device during a registration of the user.

15. The system according to claim 14, wherein the one or more processors are further configured to generate the sample voiceprint of the user by performing the one or more speech processing operations on the sample voice input of the user.

16. The system according to claim 12, wherein the one or more processors are further configured to stream multimedia content to the user-computing device, wherein the multimedia content comprises the query.

17. The system according to claim 16, wherein the one or more processors are further configured to:
preclude streaming of the multimedia content to the user-computing device, and
transmit a first notification to the user-computing device, when the authentication of the user fails.

18. The system according to claim 12, wherein the one or more processors are further configured to generate an overlay score based on the comparison of the text content with the set of pre-defined answers, wherein the overlay score corresponds to a degree of similarity between the text content and the set of pre-defined answers.

19. The system according to claim 18, wherein the one or more processors are further configured to transmit a second notification to the user-computing device, when the user is authenticated, wherein the second notification comprises the overlay score.

20. A computer program product for use with a computer, the computer program product comprising a non-transitory computer readable medium, wherein the non-transitory computer readable medium stores a computer program code for voice-based user authentication and content evaluation, wherein the computer program code is executable by one or more processors to:
operate one or more transceivers to receive a voice input of a user from a user-computing device, wherein the voice input corresponds to a response to a query;
authenticate the user based on a comparison of a voiceprint of the voice input and a sample voiceprint of the user, wherein the voiceprint is generated by performing one or more speech processing operations on the voice input; and
evaluate content of the response of the user based on a comparison of text content and a set of pre-defined answers to the query, wherein the text content is determined based on the received voice input, wherein the set of pre-defined answers comprises one or more correct answers, to the query, in a text format.
